(19) United States
(12) Patent Application Publication
(10) Pub. No.: US 2018/0270389 A1
(43) Pub. Date: Sep. 20, 2018

(54) RELAY APPARATUS, CONTROL METHOD, AND STORAGE MEDIUM

(71) Applicant: CANON KABUSHIKI KAISHA, Tokyo (JP)

(72) Inventor: Takuya Natori, Toride-shi (JP)

(21) Appl. No.: 15/910,220

(22) Filed: Mar. 2, 2018

(30) Foreign Application Priority Data
Mar. 17, 2017 (JP) 2017-053657

(51) Int. Cl. H04N 1/32; H04N 1/00; G06F 3/12; B33Y 50/00

(52) U.S. Cl. CPC H04N 1/32406; H04N 1/00649; B33Y 50/00; G06F 3/1288; G06F 3/1258; G06F 3/1297

(57) ABSTRACT

A relay apparatus is connected to a forming apparatus that forms a three-dimensional object, and receives a forming request for the forming apparatus from a client terminal. The relay apparatus receives model data corresponding to a three-dimensional object to be formed from the client terminal, receives a simple forming request for designating forming content without directly using specific setting values supported by the forming apparatus from the client terminal, converts the simple forming request into specific setting values using a database, and transmits the model data and the converted specific setting values to the forming apparatus for forming a three-dimensional object.

### BACKGROUND OF THE INVENTION

### Field of the Invention

The present invention relates to a relay apparatus, a control method, and a storage medium.

### Description of the Related Art

In recent years, a forming apparatus for forming a three-dimensionally shaped object (three-dimensional object), a so-called 3D printer, has been widely used. Japanese Patent Laid-Open No. 2015-229349 discloses an apparatus which detects a printing error and corrects the error during a printing operation for producing a 3D object using a printer.

However, even if correction is performed during a printing operation as in the apparatus disclosed in Japanese Patent Laid-Open No. 2015-229349, it is necessary to perform appropriate forming settings based on performance of a forming apparatus, a property of a material, or characteristics of model data. However, there are various types of setting value for performing a forming request on a general forming apparatus, and thus it is difficult for a user unfamiliar with the forming apparatus to perform appropriate forming settings.

### SUMMARY OF THE INVENTION

The present invention provides a relay apparatus which can perform appropriate forming settings by a simple operation when a user performs a forming request on a forming apparatus.

A relay apparatus according to an embodiment of the present invention is a relay apparatus that is connected to a forming apparatus which forms a three-dimensional object and receives a forming request for the forming apparatus from a client terminal. The relay apparatus comprises a memory storing instructions and a processor which is capable of executing the instructions causing the relay apparatus to: receive data corresponding to a three-dimensional object to be formed from the client terminal; receive a first forming request for designating forming content without directly using specific setting values supported by the forming apparatus from the client terminal; convert the first forming request into specific setting values using a conversion table; and transmit the data and the converted specific setting values to the forming apparatus for forming a three-dimensional object.

Further features of the present invention will become apparent from the following description of exemplary embodiments (with reference to the attached drawings).

### BRIEF DESCRIPTION OF THE DRAWINGS

FIG. 1 is a diagram which shows a configuration example of a forming system in one embodiment of the present invention.

FIG. 2 is a diagram which shows a hardware configuration example of a forming apparatus.

FIG. 3 is a diagram which shows a hardware configuration example of a relay apparatus and a client terminal.

FIG. 4 is a diagram which shows a software configuration example of each device constituting a forming system.

FIG. 5 is a sequence diagram which shows a flow of processing according to a first embodiment.

FIG. 6 is a diagram which shows an example of a screen on which a forming start instruction can be performed via an application.

FIG. 7 is a diagram which shows an example of a simple forming setting screen.

FIG. 8 is a diagram which shows an example of a database used for conversion processing of setting values.

FIG. 9 is a diagram which shows an example of comparative data.

FIG. 10 is a diagram which shows a software configuration example of each device constituting the forming system.

FIG. 11 is a sequence diagram which shows a flow of processing according to a second embodiment.

FIGS. 12A and 12B are diagrams which show examples of an application screen.

### DESCRIPTION OF THE EMBODIMENTS

Hereinafter, embodiments of the present invention will be described with reference to attached drawings and the like.

### First Embodiment

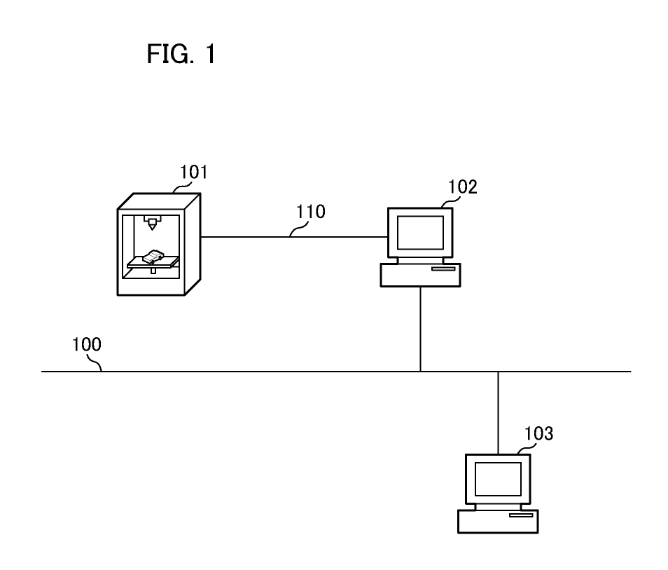

FIG. 1 is a diagram which shows a configuration example of a forming system in the present embodiment.

A forming apparatus 101 and a relay apparatus 102 are connected by a relay line 110, and the relay apparatus 102 and a client terminal 103 are connected by a network 100. The relay line 110 may be the same as the network 100.

An OS and an application are installed in the client terminal 103. A user transmits a forming request to the forming apparatus 101 via the relay apparatus 102 using the application of the client terminal 103. In addition, the user can execute preview displaying, capturing, customizing, or the like in a three-dimensional space of a corresponding three-dimensional object with respect to model data using the application of the client terminal 103. The model data is in a format such as a 3D manufacturing format (3MF), a standard template library (STL), or the like.

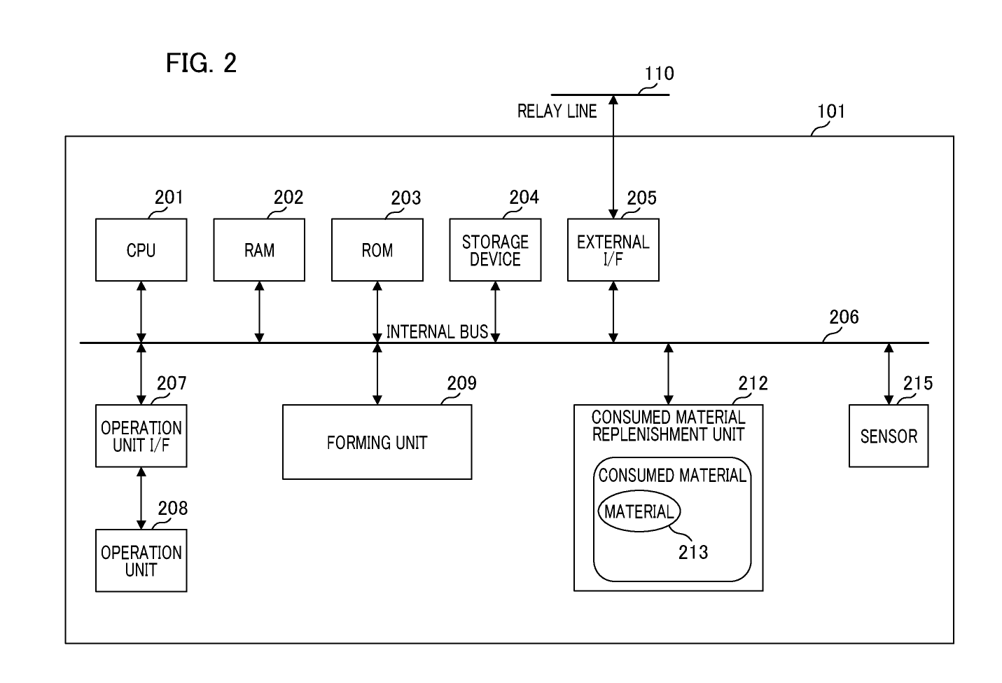

FIG. 2 is a diagram which shows a hardware configuration example of the forming apparatus 101.

A CPU 201 executes a program stored in a ROM 203 or a storage device 204, and collectively controls each device via an internal bus 206. A RAM 202 functions as a memory or a work area of the CPU 201. An embedded program and data are recorded in the ROM 203. In addition, individual identification information, model information, and the like of the forming apparatus 101 are also stored in the ROM 203.

An external I/F 205 is used for exchanging data unidirectionally or bidirectionally with the relay apparatus 102 via the relay line 110. The storage device 204 functions as an external storage device, and can store operation information or information on a consumed material which is detected and recorded in the forming apparatus 101 instead of the RAM 202 in addition to forming data and the like. The operation information includes failure information, status information, log information, and the like.

An operation unit 208 is responsible for an input/output for the forming apparatus 101. Specifically, the operation unit 208 receives an input such as a button input from a user and transmits a signal corresponding to the input to each of the above-described processing units via an operation unit I/F 207. In addition, the operation unit 208 includes a display device for providing necessary information to a user or receiving a user operation. The display device is, for example, a touch panel.

A forming unit 209 includes a dedicated controller that includes a processor and a memory for controlling a forming process depending on additive manufacturing and a stage on which materials are repeatedly layered to produce a three-dimensional object. In addition, the forming unit 209 also includes a configuration and the like depending on the additive manufacturing for layering materials, solidifying and finishing a three-dimensional object, forming a support portion, and the like.

Examples of the additive manufacturing to which the present invention can be applied include, for example, a thermal melting and stacking method known as Fused deposition modeling (FDM), Stereolithography (SLA), Selective laser sintering (SLS), an ink jet scheme, or the like. The repeatedly layering of the material by the forming unit 209 is executed using a forming command corresponding to cross-sectional shape data of each layer (slice data) generated on the basis of model data and the like using a 3D print application installed in the client terminal 103 and the like.

A consumed material replenishment unit 212 supplies a consumed material containing a material 213 required for forming a three-dimensional object to the forming unit 209. In a forming apparatus which adopts an additive manufacturing for forming a support portion when a three-dimensional object is formed, the consumed material replenishment unit 212 holds a support material as a consumed material and supplies it to the forming unit 209. The material 213 has various types such as UV curable resin, thermoplastic resin, metal powder, a gypsum material, and the like. The UV curable resin includes, for example, a liquid type resin which is cured by irradiation with ultraviolet light or the like.

In addition, the consumed material replenishment unit 212 can manage a supply amount of the material 213, support members, or the like to the forming unit 209. The supply amount is recorded as a log in the storage device 204. For the recorded log, a supply amount for each object (one job) to be formed is recorded for each one record. As for log recording, it is also possible to record a supply amount in a predetermined period of time in addition to each object.

In addition, if the forming apparatus 101 is capable of colored forming using a plurality of colors, the consumed material replenishment unit 212 can replenish the forming unit 209 with a material 213 of each of the plurality of colors, and manage a supply amount individually for each color. Then, these supply amounts can be recorded in the storage device 204 as a log. The replenishment of a consumed material to the consumed material replenishment unit 212 is performed by attaching a bottle containing a material 213 such as a liquid or a powder to the consumed material replenishment unit 212. Alternatively, the consumed material replenishment unit 212 may be replenished with a consumed material manually from a dedicated bottle or the like.

A plurality of sensors 215 are disposed in the forming apparatus 101, and each has a purpose. An example of the sensor disposed in the forming apparatus 101 will be mainly described below. A certain sensor detects a supply amount of a consumed material to the forming unit 209, which is managed by the consumed material replenishment unit 212, and detects a remaining amount of a consumed material held by the consumed material replenishment unit 212. In addition, a sensor which detects an attachment of a bottle containing the material 213 and detects identification information and the like of the bottle may be disposed in the forming apparatus 101.

In addition, a sensor for detecting a temperature abnormality, failure, or the like in the forming unit 209 is disposed. If there is a forming head or a stage for forming processing in the forming unit 209, a sensor for counting the number of driving times (a moving distance) is disposed in the forming unit 209. Although an example in which the above-described sensors are disposed as hardware is described, some or all of these sensors may be replaced with a software sensor having an equivalent detection function.

Moreover, the forming apparatus 101 includes auxiliary facilities required according to additive manufacturing or a peripheral apparatus (not shown) for extending the function and mechanism of a forming apparatus such as a camera or an IC card reader as an optional apparatus. Examples of the auxiliary facilities include required devices as powdery measures in the case of an inkjet method, required cleaning devices in the case of optical forming (SLA) method, and the like.

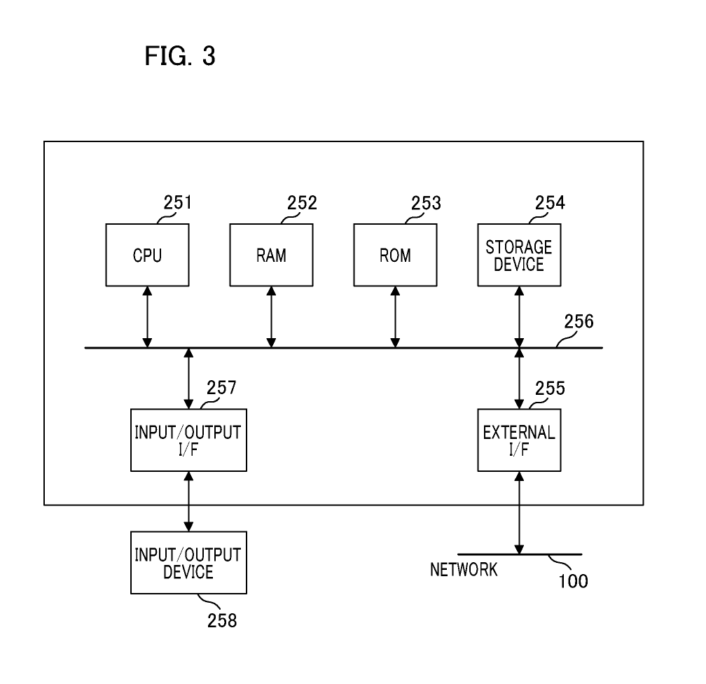

FIG. 3 is a diagram which shows a hardware configuration example of an information processing apparatus including the relay apparatus 102, the client terminal 103, and the like.

A CPU 251 executes a program and the like stored in a ROM 253 or a storage device 254, and controls an entire information processing apparatus via an internal bus 256. In addition, the ROM 253 or the storage device 254 stores various types of data in addition to the program. For example, the storage device 254 stores device information, operation information, and the like of the forming apparatus 101. A RAM 252 functions as a memory or a work area of the CPU 201.

An input/output I/F 257 is, for example, PS2, a Universal Serial Bus (USB), an analog or digital display I/F, or the like. An input/output device 258 is a keyboard, a mouse, a CRT, or a liquid crystal display. The input/output device 258 can be connected to the information processing apparatus via the input/output I/F 257. The information processing apparatus performs communication via the network 100 through an external I/F 255. There maybe a plurality of external I/Fs 255, and they may be configured to be communicable via each of the network 100 and the relay line 110.

The ROM 253 stores a basic program for controlling an initial program for starting the information processing apparatus and each module of the information processing apparatus. The storage device 254 stores an OS and an application. If the information processing apparatus is powered on, a program (boot loader) for starting a computer saved in the ROM 253 is executed first, and the program loads the OS stored in the storage device 254 into the RAM 252 and transfers a control right to the OS.

The OS reads a necessary module or driver from the storage device 254 to the RAM 252. In addition, the OS reads and executes a necessary application from the storage device 254 to the RAM 252 according to an instruction of a user. In the present embodiment, the CPU 251 loads the program stored in the storage device 254 of the information processing apparatus into the RAM 252 and executes the program, and thereby each piece of processing of the relay apparatus 102 and the client terminal 103, which will be described below, is executed.

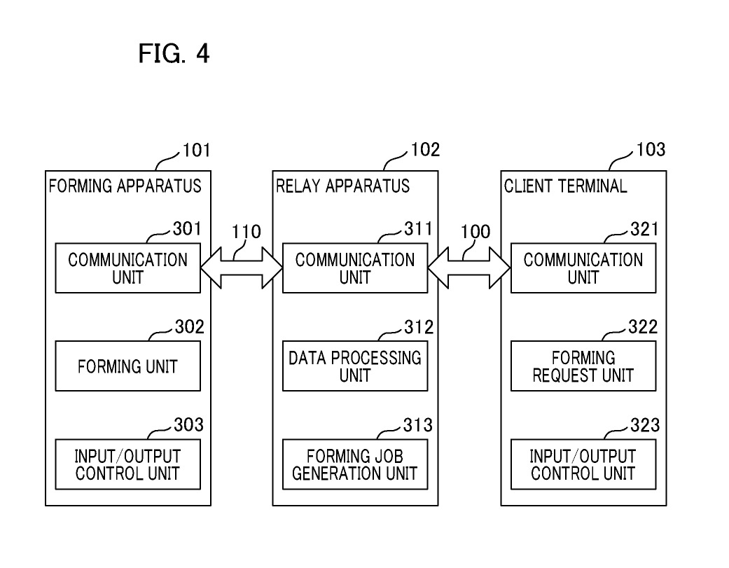

FIG. 4 is a diagram which shows a software configuration example of each device constituting the forming system in the present embodiment.

The forming apparatus 101 includes a communication unit 301, a forming unit 302, and an input/output control unit 303. The communication unit 301 communicates with the relay apparatus 102 via the relay line 110. The forming unit 302 executes a forming job in the forming apparatus 101 and outputs a three-dimensional object. The input/output control unit 303 controls input/output information from the operation unit 208.

The relay apparatus 102 includes a communication unit 311, a data processing unit 312, and a forming job generation unit 313. The communication unit 311 communicates with the forming apparatus 101 through the relay line 110 and communicates with the client terminal 103 through the network 100. The data processing unit 312 converts setting values included in a simple forming request, which will be described below, into setting values used by a printer driver, that is, specific setting values supported by the forming apparatus 101. In addition, the data processing unit 312 manages various types of data related to a forming request. The forming job generation unit 313 creates a forming request which can be interpreted by the forming apparatus 101 as a forming job.

The client terminal 103 includes a communication unit 321, a forming request unit 322, and an input/output control unit 323. The communication unit 321 communicates with the relay apparatus 102 through the network 100. The forming request unit 322 creates a forming start instruction for notifying the relay apparatus 102 of the start of the forming request. The input/output control unit 323 controls input/output information to or from the input/output device 258. A forming system is formed by the forming apparatus 101, the relay apparatus 102, and the client terminal 103 communicating with each other via the communication unit 301, the communication unit 311, and the communication unit 321.

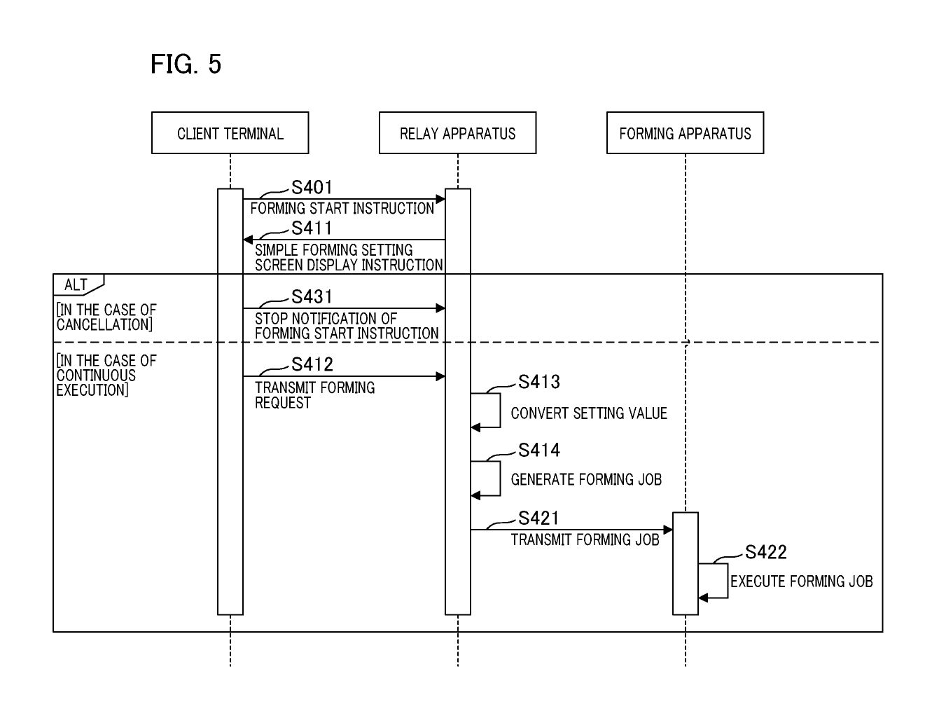

FIG. 5 is a sequence diagram which shows a flow of processing in the present embodiment.

In step S401, the client terminal 103 transmits a forming start instruction to the relay apparatus 102 on the basis of an operation of a user. The forming start instruction is transmitted via an application operating on the client terminal 103, or is transmitted via a function of an OS. The client terminal 103 requires a setting screen for designating forming content without using the specific setting values supported by the forming apparatus 101 by the forming start instruction.

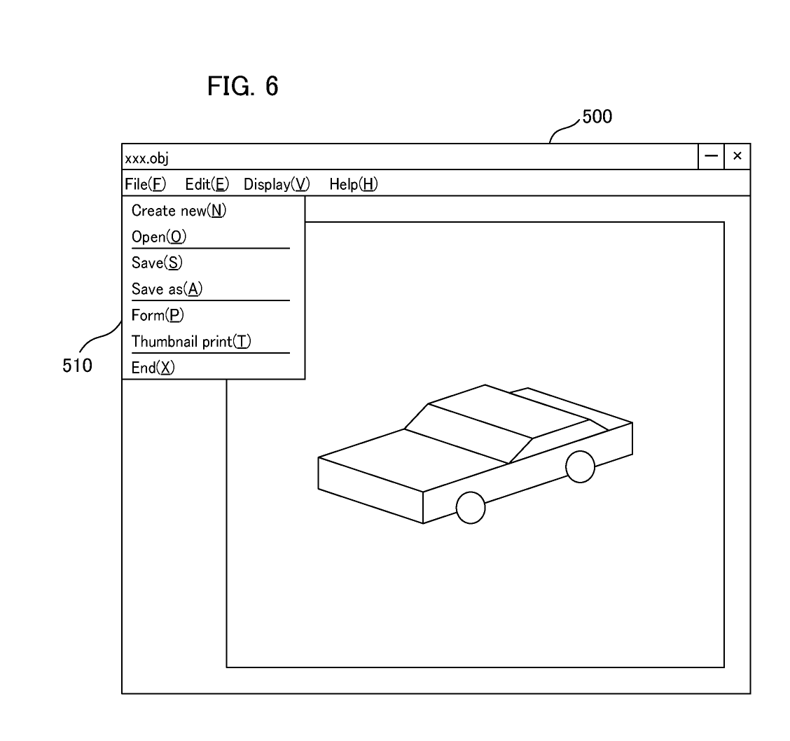

FIG. 6 is a diagram which shows an example of an application screen operating on the client terminal 103.

Specifically, FIG. 6 is a diagram which shows an example of a screen in the case in which the forming start instruction is transmitted via the application operating on the client terminal 103 in step S401. A menu 510 for performing saving of model data (3D data) being displayed on a screen 500, a forming request to the forming apparatus 101, a printing request to a printer, or the like is displayed on the screen 500. If a “forming” command is selected in the menu 510, the forming start instruction is transmitted from the client terminal 103 to the relay apparatus 102.

A format of model data is not limited. For example, the model data includes a thumbnail image from a predetermined orientation of a three-dimensional object corresponding to the 3D data as well as the 3D data. In this case, if a “thumbnail print” command in the menu 510 is selected, a print request to print a thumbnail image included in the model data on paper is transmitted to a printer. Furthermore, if a forming start instruction is transmitted via the function of the OS, for example, it is possible to perform the forming start instruction in a desktop context menu in the same manner as in the above-described menu 510.

Returning to the description of FIG. 5, in step S411, the relay apparatus 102 returns a display instruction of a simple forming setting screen to the client terminal 103. The simple forming setting screen is a screen on which a simple forming request for designating forming content can be made without directly using the specific setting values supported by the forming apparatus 101. That is, it is a screen on which a user simply performs a forming setting.

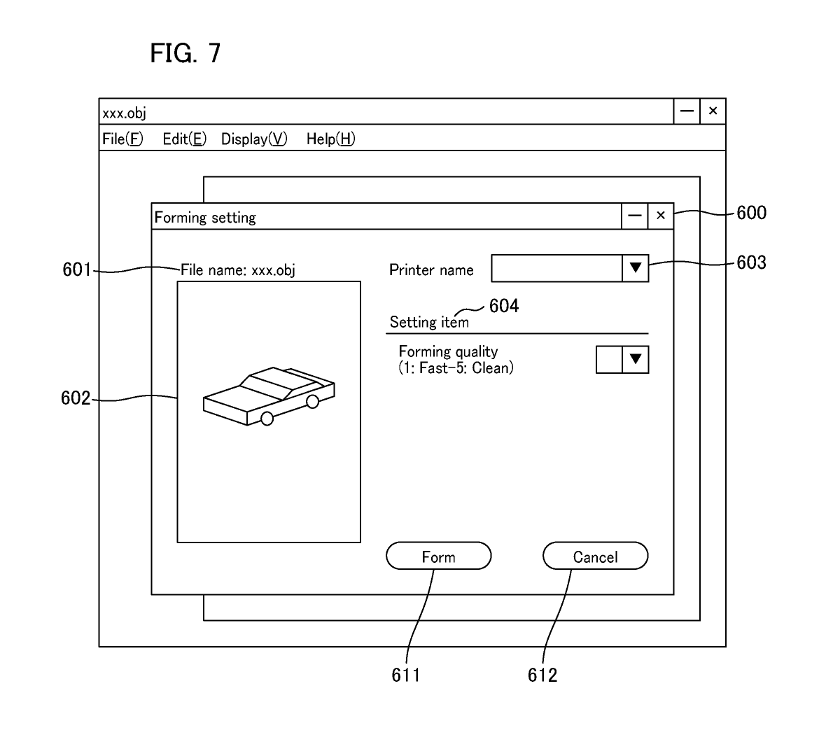

FIG. 7 is a diagram which shows an example of the simple forming setting screen according to the present embodiment.

In step S411, the client terminal 103 displays a simple forming setting screen 600 if a display instruction of a simple forming setting screen is received. A file name 601 is a name indicating model data to be formed. A thumbnail 602 is a diagram which shows an appearance of the model data to be formed indicated by the file name 601.

A printer name 603 is a name indicating the forming apparatus 101 which executes forming. A simple setting item for designating forming content is displayed as a setting item 604. The simple setting item is a setting item for a user to simply designate forming content without directly using specific setting values. In FIG. 7, forming quality is displayed as an example of the setting item 604, but the present embodiment is not limited thereto. If, for easy understanding, the setting item 604 is a setting item which allows a user to designate forming content, the setting item does not necessarily need to be a portion of the specific setting values supported by the forming apparatus 101.

A forming button 611 is a button for transmitting a forming request for designating forming content set in the simple forming setting screen 600. That is, if the forming button 611 is pressed, a simple forming request for designating forming content without directly using the specific setting values supported by the forming apparatus 101 can be transmitted. A cancellation button 612 is a button for canceling a forming start instruction and is a button for closing the simple forming setting screen 600 without transmitting a forming request.

Returning to FIG. 5, the processing proceeds to step S431 if the cancellation button 612 is pressed on the simple forming setting screen 600 (FIG. 7), and the processing proceeds to step S412 if the forming button 611 is pressed. In step S431, the client terminal 103 transmits a notification to cancel a forming start instruction to the relay apparatus 102 in step S431.

In step S412, the client terminal 103 transmits a simple forming request including setting values of the setting item 604 and model data to be formed indicated by the file name 601 to the relay apparatus 102. In step S413, the relay apparatus 102 executes conversion processing of converting the setting values of the setting item 604 received in step S412 into specific setting values supported by the forming apparatus 101. In the conversion processing of setting values, the setting values of the setting item 604 and a feature amount of the model data to be formed indicated by the file name 601 are used.

Hereinafter, the conversion processing of setting values executed in step S413 will be described. The data processing unit 312 of the relay apparatus 102 realizes the conversion processing of setting values by referring to a database in which the setting values of the setting item 604, a predetermined feature amount extracted from the model data, and predetermined setting values supported by the forming apparatus 101 are correlated.

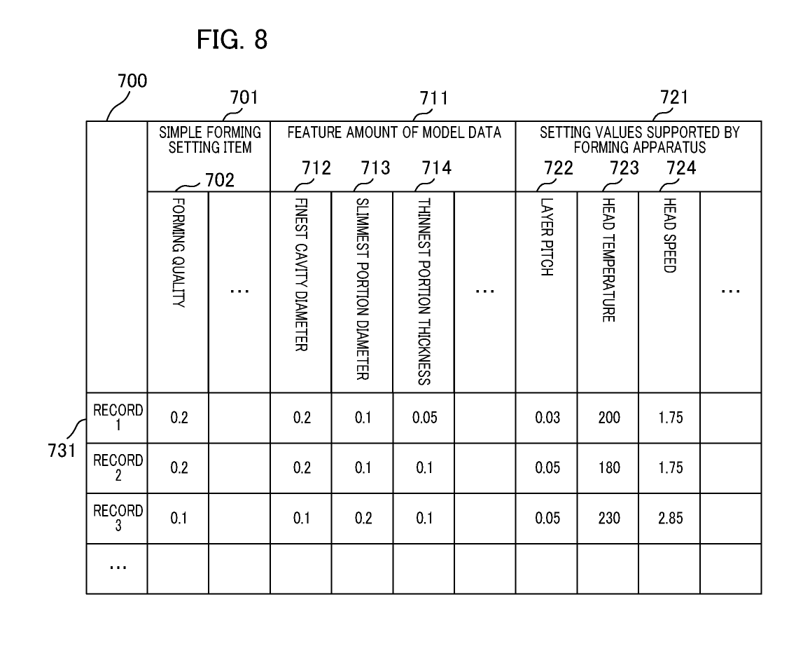

FIG. 8 is a diagram which shows an example of a database to which the data processing unit 312 of the relay apparatus 102 refers in step S413.

A database 700 is constituted by a set of records 731 having the following three attribute groups. The attribute groups of each of the records are a simple forming setting item 701, a feature amount 711 of model data, and a setting value 721 supported by a forming apparatus.

In other words, the database 700 is a conversion table in which a predetermined feature amount extracted from the model data and predetermined forming content designated by a simple forming request are correlated with the specific setting values supported by the forming apparatus 101. Specifically, the simple forming setting item 701 is constituted from attributes corresponding to setting values designated in the setting item 604 (FIG. 7). In an example shown in FIG. 8, forming quality 702 is displayed as an attribute constituting the simple forming setting item 701.

A feature amount 711 of model data to be formed is constituted from attributes corresponding to values obtained by analyzing the model data. In the example shown in FIG. 8, a “finest cavity diameter” 712, a “slimmest portion diameter” 713, and a “thinnest portion thickness” 714 are displayed as the attributes constituting the feature amount 711 of model data. The attributes constituting the feature amount 711 of model data are not limited thereto.

The setting value 721 supported by a forming apparatus is constituted from attributes corresponding to the specific setting values supported by the forming apparatus 101. In the example shown in FIG. 8, a layer pitch 722, a head temperature 723, and a head speed 724 are displayed as attributes constituting the setting value 721 supported by a forming apparatus. The attributes constituting the setting value 721 supported by a forming apparatus are not limited thereto.

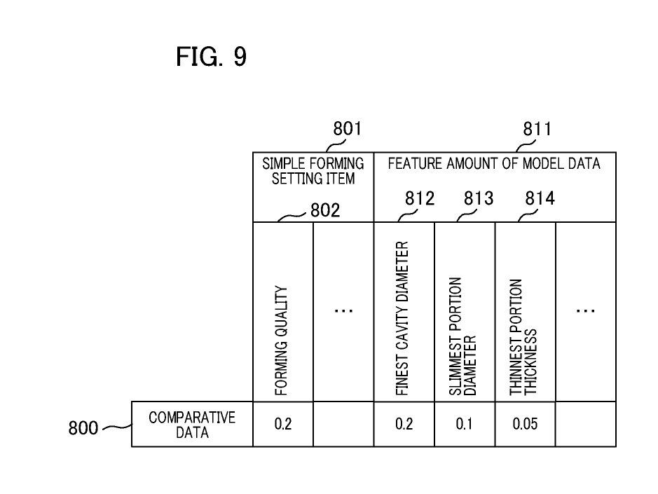

FIG. 9 is a diagram which shows an example of the setting values of the setting item 604 and the feature amount of model data to be formed indicated by the file name 601 that are received in step S412.

Comparative data 800 has the following two attribute groups. The two attribute groups are a simple forming setting item 801 and a feature amount 811 of model data, and each of the groups corresponds to an attribute group of the database 700 (FIG. 8).

In the conversion processing of setting values executed in step S413, the data processing unit 312 of the relay apparatus 102 compares each value included in the attribute groups of the comparative data 800 and values of attribute groups corresponding to each of the records 731 of the database 700, and calculates a degree of coincidence. The degree of coincidence is an index which gets higher as a difference between the compared values is smaller.

The setting value 721 supported by a forming apparatus of the record 731 having the highest degree of coincidence with the comparative data 800 among the records 731 is adopted as a result of the conversion processing of setting values executed in step S413. That is, values included in the setting value 721 supported by the forming apparatus of the records 731 having a high degree of coincidence are adopted as the specific setting values supported by the forming apparatus 101.

In the calculation of the degree of coincidence, a weighted average obtained by performing different weighting on each attribute group or each attribute may also be used. In addition, the specific setting values supported by the forming apparatus 101 may also be derived on the basis of the setting value 721 supported by a forming apparatus of a plurality of high-ranking records 731 having a high degree of coincidence in addition to the record 731 having the highest degree of coincidence.

Returning to the description of FIG. 5, the relay apparatus 102 generates a forming job in step S414. Specifically, the forming job generation unit 913 of the relay apparatus 102 designates the model data received in step S412 and the setting values obtained by conversion in step S413, and generates a forming job by using a printer driver corresponding to the forming apparatus 101. The forming job includes the model data and the specific setting values after conversion. In step S421, the relay apparatus 102 transmits a forming request to the forming apparatus 101 as the forming job generated in step S414.

In step S422, the forming apparatus 101 executes the forming job received from the relay apparatus 102 in step S421. In the present embodiment, a method of constructing the database 700 (FIG. 8) is not particularly limited. For example, the database 700 may be constructed by aggregating results of executing a large number of forming jobs under different conditions in advance. In addition, the database 700 may also be constructed on the basis of data collected from a vendor of the forming apparatus 101.

In addition, the database 700 may be data in which each of records 731 is statically fixed data or may be dynamical updated data. For example, when a forming job is completed, a mechanism may be provided in which the data processing unit 312 of the relay apparatus 102 adds a record 731 of the database 700 based on a result of the execution of the forming job to the database 700.

As described above, according to the present embodiment, when a user performs a forming request on the forming apparatus 101, it is possible to perform appropriate forming setting by a simple operation. For example, even a user who is not accustomed to using the forming apparatus can appropriately control the forming apparatus 101.

### Second Embodiment

In the first embodiment, a case in which the relay apparatus 102 receives a simple forming request from the client terminal 103 has been described. On the other hand, a case in which the relay apparatus 102 receives not only a simple forming request from the client terminal 103 but also a specific forming request interpretable by the forming apparatus 101 generated on the client terminal 103 side as a forming job will be described in the present embodiment.

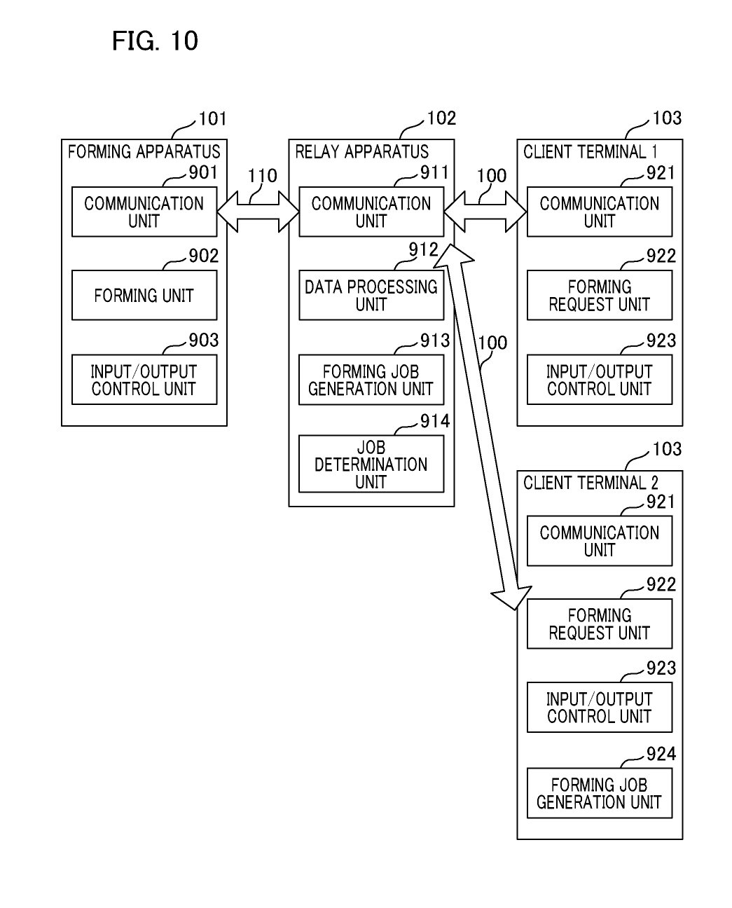

FIG. 10 is a diagram which shows a software configuration example of the forming system in the present embodiment.

Since the forming apparatus 101 is the same as a software configuration (FIG. 4) of the first embodiment, description thereof will be omitted. The relay apparatus 102 includes a communication unit 911, a data processing unit 912, a forming job generation unit 913, and a job determination unit 914.

Since the communication unit 911, the data processing unit 912, and the forming job generation unit 913 are the same as software configurations (FIG. 4) of the first embodiment, descriptions thereof will be omitted. The job determination unit 914 determines whether a client terminal performs a simple forming request or a specific forming request on the basis of a forming start instruction received from the client terminal 103.

The client terminal 103, like the software configuration (FIG. 4) of the first embodiment, includes a communication unit 921, a forming request unit 922, and an input/output control unit 923. In addition, the client terminal 103 may include a forming job generation unit 924 in addition to the communication unit 921, the forming request unit 922, and the input/output control unit 923 in the present embodiment. The forming job generation unit 924 generates a forming request which can be interpreted by the forming apparatus 101 as a forming job.

In the present embodiment, the client terminal 103 transmits a simple forming request to the relay apparatus 102 in the same manner as in the first embodiment. In addition, the client terminal 103 may transmit a specific forming request including specific setting values supported by the forming apparatus 101, which is generated by the forming job generation unit 924, as a forming job. The forming system in the present embodiment is formed by the forming apparatus 101, the relay apparatus 102, and the client terminal 103 communicating with each other via the communication unit 901, the communication unit 911, and the communication unit 921.

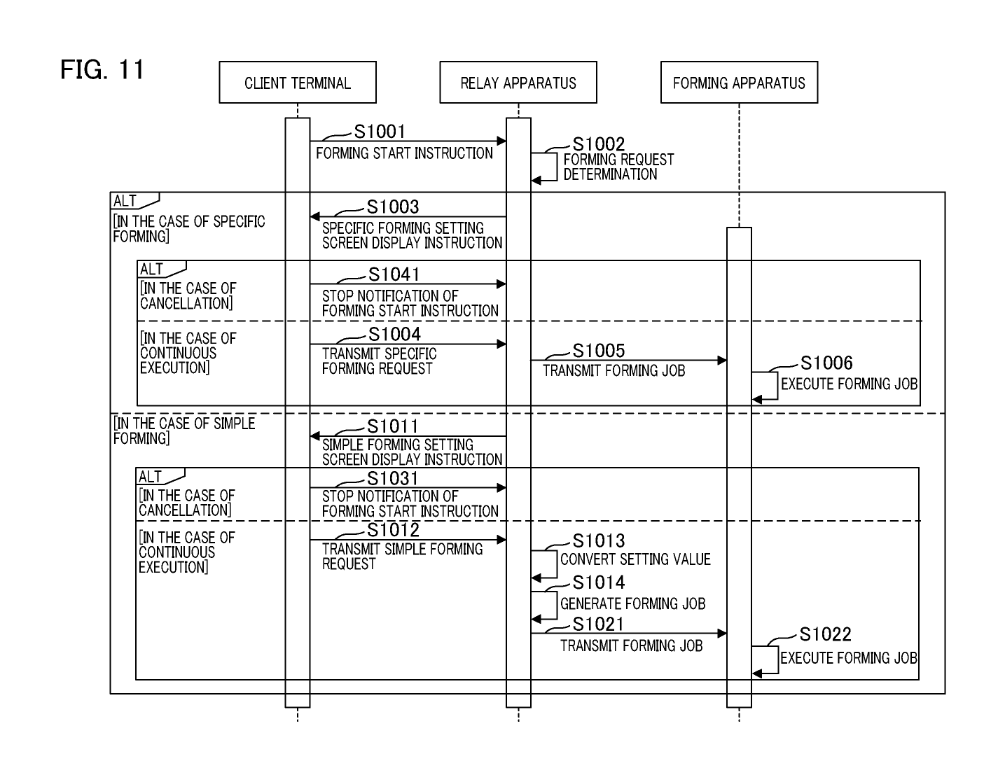

FIG. 11 is a sequence diagram which shows a flow of processing in the present embodiment.

In step S1001, the client terminal 103 transmits a forming start instruction to the relay apparatus 102 on the basis of an operation of a user. The forming start instruction is transmitted via an application operating on the client terminal 103, or is transmitted via a function of an OS. The client terminal 103 requires a simple forming setting screen for designating forming content without using the specific setting values supported by the forming apparatus 101 or a specific forming setting screen using the specific setting values.

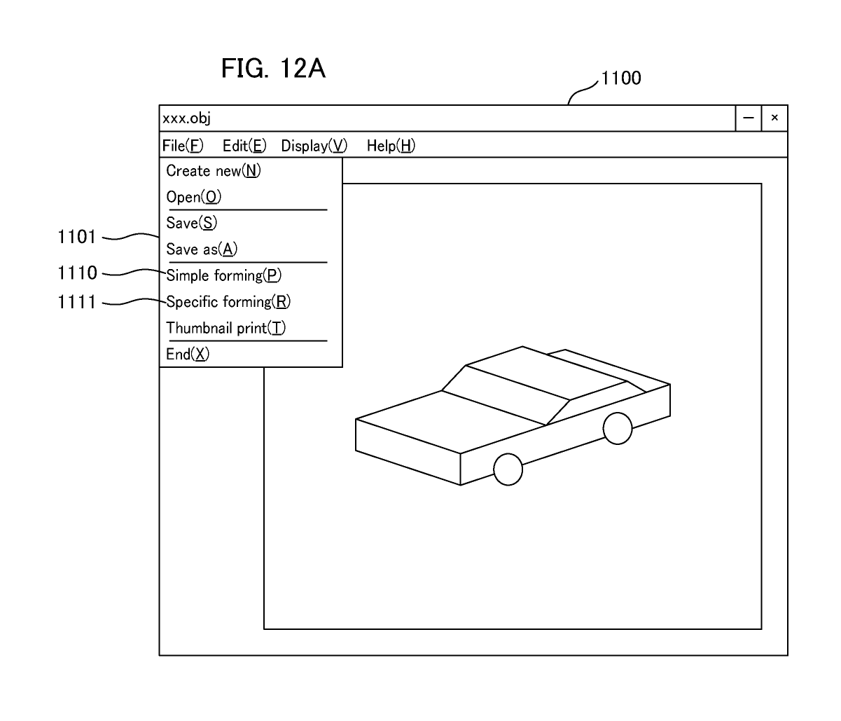

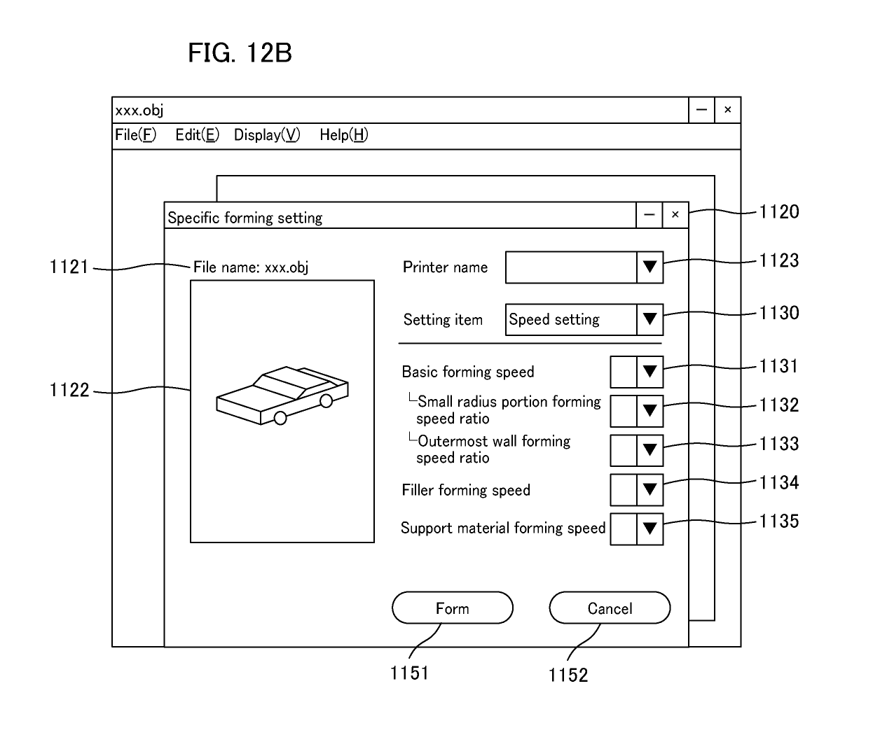

FIG. 12A is a diagram which shows an example of an application screen operating on the client terminal 103.

Specifically, FIG. 12A is a diagram which shows an example of a screen in a case in which a forming start instruction is transmitted via an application operating on the client terminal 103 in step S1001. A menu 1101 is displayed on a screen 1100 in the same manner as in the first embodiment.

In the present embodiment, the menu 1101 includes a “simple forming” command 1110 and a “specific forming” command 1111. If the “simple forming” command 1110 or the “specific forming” command 1111 is selected in the menu 1101, a forming start instruction is transmitted from the client terminal 103 to the relay apparatus 102 in the same manner as the case in which the “forming” command (FIG. 6) of the first embodiment is selected.

If the “simple forming” command 1110 is selected, the client terminal 103 requires a simple forming setting screen for designating forming content without using the specific setting values supported by the forming apparatus 101 according to the forming start instruction. In addition, if the “specific forming” command 1111 is selected, the client terminal 103 requires a specific forming setting screen for designating forming content using the specific setting values according to the forming start instruction. If, for example, the forming start instruction is transmitted via the function of the OS, it is possible to perform the forming start instruction in a desktop context menu in the same manner as in the above-described menu 1101.

Returning to the description of FIG. 11, the job determination unit 914 of the relay apparatus 102 determines whether the forming start instruction received in step S1001 is transmitted according to the “simple forming” command 1110 or transmitted according to the “specific forming” command 1111 in step S1002. In step S1002, the processing proceeds to step S1031 if it is determined that the forming start instruction is transmitted according to the “simple forming” command 1110, and the processing proceeds to step S1003 if it is determined that the forming start instruction is transmitted according to the “specific forming” command.

In step S1003, the relay apparatus 102 returns a display instruction of a specific forming setting screen to the client terminal 103. A specific forming setting screen is a screen on which a specific forming request for designating forming content using specific setting values can be performed.

FIG. 12B is a diagram which shows an example of the specific forming setting screen.

The client terminal 103 displays a specific forming setting screen 1120 if a display instruction of the specific forming setting screen is received. The specific forming setting screen 1120, like the simple forming setting screen (FIG. 7), has a file name 1121, a thumbnail 1122, and a printer name 1123. In addition, specific setting is available for each setting item 1130 which can be set by a printer driver on the specific forming setting screen 1120.

That is, specific setting values supported by the forming apparatus 101 can be set for each of the setting items 1130. For example, in the example shown in FIG. 12B, a “forming speed” is selected as the setting item 1130. At this time, a “basic forming speed” 1131 for setting a basic forming speed, a “small radius portion forming speed ratio” 1132 and an “outermost wall forming speed ratio” 1133 for the “basic forming speed” 1131 can be designated as specific setting values concerning the forming speed.

The “small radius portion forming speed ratio” 1132 is a ratio of a speed at a time at which a small radius portion for expressing a hole or the like is formed to the “basic forming speed” 1131. In addition, the “outermost wall forming speed ratio” 1133 is a ratio of a speed at a time at which the outermost wall portion corresponding to a portion visible from the outside of a three-dimensional object is formed to the “basic forming speed” 1131.

Furthermore, it is possible to designate a “filler forming speed” 1134 and a “support material forming speed” 1135 as the specific setting values concerning a forming speed. The “filler forming speed” 1134 sets a speed at a time at which a filler corresponding to a portion invisible from the outside of a three-dimensional object is formed. The “support material forming speed” 1135 sets a speed at a time at which a support material is formed.

The setting item 1130 is not limited to the forming speed, and may include, for example, a layer pitch, a filling method, a setting of a support material, and the like. In addition, the specific forming setting screen 1120, like the simple forming setting screen (FIG. 7), has a forming button 1151 and a cancellation button 1152. The forming button 1151 is a button for transmitting a specific forming request which uses specific setting values set on the specific forming setting screen 1120 to the relay apparatus 102.

Specifically, if the forming button 1151 is pressed, the client terminal 103 generates a specific forming request containing the specific setting values set on the specific forming setting screen 1120 and model data to be formed, which is indicated by the file name 1121. Then, the client terminal 103 transmits the forming request to the forming apparatus 101 via the relay apparatus 102 as a forming job.

Returning to the description of FIG. 11, the processing proceeds to step S1041 if the cancellation button 1152 is pressed on the specific forming setting screen 1120 (FIG. 12B), and the processing proceeds to step S1004 if the forming button 1151 is pressed. In step S1041, the client terminal 103 transmits a notification to stop a forming start instruction to the relay apparatus 102.

In step S1004, the client terminal 103 generates a specific forming request containing setting values for each of the setting items 1130 and the model data to be formed, which is indicated by the file name 1121, and transmits the forming request to the relay apparatus 102 as a forming job. In step 51105, the relay apparatus 102 transmits the received forming job to the forming apparatus 101. In step S1006, the forming apparatus 101 executes the received forming job.

On the other hand, the processing proceeds to step S1011 if it is determined that the forming start instruction is transmitted according to the “simple forming” command in S1002. Since processing of steps S1011 to S1014, S1021, S1022, and S1031 are the same as the processing of step S412 to S414, S421, S422, and S431 in the first embodiment, descriptions thereof will be omitted.

As described above, according to the present embodiment, the same effects as in the first embodiment can be obtained. Furthermore, a user who is familiar with the forming apparatus 101 can control the forming apparatus 101 by directly using specific setting values according to the present embodiment.

In the first embodiment and the second embodiment, the relay apparatus 102 is an apparatus different from the client terminal 103 and the forming apparatus 101, but the present invention is not limited thereto. The client terminal 103 or the forming apparatus 101 may be configured to have the functions of the above-described relay apparatus 102. For example, the client terminal 103 may have the functions of the data processing unit 312 and the forming job generation unit 313 of the relay apparatus 102 in the first embodiment, and the present invention may be realized by the client terminal 103 directly communicating with the forming apparatus 101.

In addition, in the first embodiment and the second embodiment, the database 700 is stored in the relay apparatus 102, more specifically, in the storage device 254, but the present invention is not limited thereto. The relay apparatus 102 may also be stored in an apparatus on the network 100 which can communicate via the external I/F 255. For example, the database 700 may be managed on a cloud.

Moreover, in step S412, the client terminal 103 transmits model data to be formed and setting values of the setting item 604 to the relay apparatus 102 as a simple forming request, but the present invention is not limited thereto. The client terminal 103 may calculate a feature amount by analyzing the model data to be formed, and transmit the feature amount to the relay apparatus 102.

### Other Embodiments

Embodiment(s) of the present invention can also be realized by a computer of a system or apparatus that reads out and executes computer executable instructions (e.g., one or more programs) recorded on a storage medium (which may also be more fully referred to as a “non-transitory computer-readable storage medium”) to perform the functions of one or more of the above-described embodiment (s) and/or that includes one or more circuits (e.g., application specific integrated circuits (ASICs)) for performing the functions of one or more of the above-described embodiment(s), and through a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing units (CPUs) and micro processing units (MPUs)) and may include a network of separate computers or separate processors to read and execute the computer executable instructions. The computer executable instructions may be provided to the computer, for example, from a network or the storage medium. The storage medium may include, for example, one or more of a hard disk, a random-access memory (RAM), a read-only memory (ROM), storages of distributed computing systems, an optical disk (such as a compact disc (CD), a digital versatile disc (DVD), or a Blu-ray Disc (BD)™), a flash memory device, a memory card, and the like.

While the present invention has been described with reference to exemplary embodiments, it should be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2017-053657, filed Mar. 17, 2017, which is hereby incorporated by reference wherein in its entirety.

What is claimed is:

1. A relay apparatus that is connected to a forming apparatus which forms a three-dimensional object and receives a forming request for the forming apparatus from a client terminal, the relay apparatus comprising:
a memory storing instructions; and
a processor which is capable of executing the instructions causing the relay apparatus to:
receive data corresponding to a three-dimensional object to be formed from the client terminal;
receive a first forming request for designating forming content without directly using specific setting values supported by the forming apparatus from the client terminal;
convert the first forming request into specific setting values using a conversion table; and
transmit the data and the converted specific setting values to the forming apparatus for forming a three-dimensional object.

2. The relay apparatus according to claim 1,
wherein the instructions further cause the relay apparatus to provide the client terminal with a screen on which the first forming request can be performed.

3. The relay apparatus according to claim 1,
wherein the conversion table is managed on the relay apparatus or a cloud.

4. The relay apparatus according to claim 1,
wherein the conversion table is a table in which a predetermined feature amount extracted from data corresponding to a three-dimensional object and predetermined forming content designated according to the first forming request are correlated with the specific setting values.

5. The relay apparatus according to claim 4,
wherein, in the conversion, the predetermined feature amount and the predetermined forming content of the conversion table are extracted on the basis of the data and the first forming request received from the client terminal, and the specific setting values corresponding to the extracted predetermined feature amount and the extracted predetermined forming content are set as the specific setting values in which the first forming request is converted in the conversion table.

6. The relay apparatus according to claim 1,
wherein the instructions further cause the relay apparatus to transmit a forming request containing the data corresponding to the three-dimensional object to be formed and the setting values to the forming apparatus without performing the conversion if a second forming request for designating forming content using the specific setting values is received from the client terminal.

7. The relay apparatus according to claim 6,
wherein the second forming request is transmitted to the relay apparatus as a job generated by the client terminal using the data corresponding to the three-dimensional object to be formed and the specific setting value, and a forming request transmitted to the forming apparatus by the relay apparatus is the job.

8. The relay apparatus according to claim 6,
wherein the instructions further cause the relay apparatus to provide the client terminal with a screen on which the second forming request can be performed.

9. The relay apparatus according to claim 1,
wherein, if a request to start forming is received from the client terminal, it is determined whether or not the client terminal performs the first forming request.

10. The relay apparatus according to claim 1,
wherein the client terminal is capable of performing the first forming request and a printing request of a thumbnail image of a three-dimensional object using the data corresponding to the three-dimensional object to be formed.

11. The relay apparatus according to claim 10,
wherein, if the printing request of a thumbnail image is performed, the printing request is transmitted as a job to a printing apparatus that performs printing on a sheet of paper.

12. The relay apparatus according to claim 1,
wherein forming content designated as the first forming request includes at least forming quality.

13. A non-transitory storage medium on which is stored a computer program for making a computer execute a method for controlling a relay apparatus that is connected to a forming apparatus which forms a three-dimensional object and receives a forming request for the forming apparatus from a client terminal, the method comprising:
receiving data corresponding to a three-dimensional object to be formed from the client terminal;
receiving a first forming request for designating forming content without directly using specific setting values supported by the forming apparatus from the client terminal;
converting the first forming request into specific setting values using a conversion table; and
transmitting the data and the converted specific setting values to the forming apparatus for forming a three-dimensional object.

14. A method for controlling a relay apparatus that is connected to a forming apparatus which forms a three-dimensional object and receives a forming request for the forming apparatus from a client terminal, the method comprising:
receiving data corresponding to a three-dimensional object to be formed from the client terminal;
receiving a first forming request for designating forming content without directly using specific setting values supported by the forming apparatus from the client terminal;
converting the first forming request into specific setting values using a conversion table; and
transmitting the data and the converted specific setting values to the forming apparatus for forming a three-dimensional object.
